(19) United States
(12) Patent Application Publication
(10) Pub. No.: US 2021/0164489 A1
(43) Pub. Date: Jun. 3, 2021

(54) COMPRESSOR HAVING EXTENDED RANGE AND STABILITY

(71) Applicant: Carrier Corporation, Palm Beach Gardens, FL (US)

(72) Inventors: Michael M. Joly, Hebron, CT (US); Ulf J. Jonsson, South Windsor, CT (US); William T. Cousins, Glastonbury, CT (US); Vishnu M. Sishtla, Manlius, NY (US)

(21) Appl. No.: 17/045,054

(22) PCT Filed: Apr. 10, 2019
(86) PCT No.: PCT/US2019/026777

§ 371 Date: Oct. 2, 2020

Related U.S. Application Data
(60) Provisional application No. 62/655,488, filed on Apr. 10, 2018.

(51) Int. Cl. F04D 29/42; F04D 29/44

(52) U.S. Cl. CPC F04D 29/4206; F04D 29/441; F05D 2250/38; F05D 2260/20; F05D 2220/30; F05D 2250/70; F05D 2260/60; F05D 2220/40

(57) ABSTRACT

A ported shroud (60) for use in a compressor includes a body having a first end (42) and a second opposite end (46). The body is disposed concentrically about an axial passageway (50) and includes an inlet (40) for receiving a fluid flow formed adjacent the first end (42) and an outlet port (70) for discharging the fluid flow formed adjacent the second end (46). A toroidal volute (74) is disposed within the interior of the body and fluidly couples the inlet and the outlet.

### BACKGROUND

Embodiments of the disclosure relate generally to a refrigeration system, and more particularly, to a ported shroud for extending the range of a centrifugal compressor.

Rotary machines are commonly used in refrigeration and turbine applications. An example of a rotary machine includes a centrifugal compressor having an impeller fixed to a rotating shaft. Rotation of the impeller increases a pressure and/or velocity of a fluid or gas moving across the impeller. The impeller is typically surrounded by a generally conical or bell-shaped shroud, which helps guide the flow from the forward section to the aft section of the impeller. Certain benefits in impeller performance can be realized by forming one or more ports through the impeller shroud to allow fluid flow in one of two directions depending upon the operational conditions of the impeller. The flow extracted from the impeller under outflow conditions may be discharged from the compressor, provided to another component of the system, or possibly redirected back to the inlet of the impeller by a recirculation flow pathway for reingestion by the impeller.

Conventionally, constraints on the arrangement of components require the bleed outlet to remain in close proximity upstream of the impeller inducer. Such positioning of the bleed outlet impacts the profile of the impeller inlet flow, which must be accounted for in the design of the compressor. For a wide flow capability compression system, such as those used in chiller applications for example, it may be difficult to maintain desired performance over the full flow range of the compressor.

### BRIEF DESCRIPTION

According to an embodiment, a ported shroud for use in a compressor includes a body having a first end and a second opposite end. The body is disposed concentrically about an axial passageway and includes an inlet for receiving a fluid flow formed adjacent the first end and an outlet port for discharging the fluid flow formed adjacent the second end. A toroidal volute is disposed within the interior of the body and fluidly couples the inlet and the outlet.

In addition to one or more of the features described above, or as an alternative, in further embodiments at least one of a size and contour of the inlet is selected based on a pressure distribution within the compressor.

In addition to one or more of the features described above, or as an alternative, in further embodiments the inlet includes a slot.

In addition to one or more of the features described above, or as an alternative, in further embodiments the slot extends circumferentially about the axial passageway.

In addition to one or more of the features described above, or as an alternative, in further embodiments the slot includes a ramped surface extending from the first end toward the second end.

In addition to one or more of the features described above, or as an alternative, in further embodiments the ramped surface gradually increases in distance from the first end about a circumferential of the axial passageway, the distance being measured parallel to an axis of the axial passageway.

According to another embodiment, a compressor includes a housing including an inlet opening formed at a first end of the housing and an internal wall extending from the inlet opening to define a passageway. An impeller including at least one impeller blade is rotatable about an axis and is positioned adjacent an end of the passageway for receiving a fluid flow there through. A ported shroud is positioned adjacent at least a portion of the internal wall. The ported shroud includes an internal volute and includes a first opening in fluid communication with a leading edge of the at least one impeller blade.

In addition to one or more of the features described above, or as an alternative, in further embodiments the ported shroud includes a second opening in fluid communication with a component external to the compressor.

In addition to one or more of the features described above, or as an alternative, in further embodiments during outflow operation, fluid is provided to the ported shroud through the first opening and is discharged from the ported shroud through the second opening.

In addition to one or more of the features described above, or as an alternative, in further embodiments during inflow operation, fluid is provided to the ported shroud through the second opening and is discharged from the ported shroud through the first opening.

In addition to one or more of the features described above, or as an alternative, in further embodiments the ported shroud is integrally formed with the internal wall of the housing.

In addition to one or more of the features described above, or as an alternative, in further embodiments the ported shroud is coupled to the internal wall of the housing.

In addition to one or more of the features described above, or as an alternative, in further embodiments the internal volute is toroidal in shape.

In addition to one or more of the features described above, or as an alternative, in further embodiments the internal volute extends about the periphery of the internal wall.

In addition to one or more of the features described above, or as an alternative, in further embodiments at least one of a size and contour of the first opening is selected based on a pressure distribution within the compressor.

In addition to one or more of the features described above, or as an alternative, in further embodiments the first opening includes a slot.

In addition to one or more of the features described above, or as an alternative, in further embodiments the slot extends circumferentially about the axial passageway.

In addition to one or more of the features described above, or as an alternative, in further embodiments the slot includes a ramped surface extending from the first end toward the second end.

In addition to one or more of the features described above, or as an alternative, in further embodiments the ramped surface gradually increases in distance from the first end about a circumferential of the axial passageway, the distance being measured parallel to an axis of the axial passageway.

### BRIEF DESCRIPTION OF THE DRAWINGS

The following descriptions should not be considered limiting in any way. With reference to the accompanying drawings, like elements are numbered alike:

FIG. 1 is a cross-sectional view of a known centrifugal compressor;

FIG. 2A is a cross-sectional view of a portion of a centrifugal compressor including a ported shroud according to an embodiment;

FIG. 2B is a perspective, partially cut away view of a portion of a centrifugal compressor including a ported shroud according to an embodiment;

FIG. 2C is another perspective, partially cut away view of a portion of a centrifugal compressor including a ported shroud according to an embodiment;

FIG. 3A is a perspective view of a ported shroud according to an embodiment;

FIG. 3B is another perspective view of a ported shroud according to an embodiment;

FIG. 3C is a cross-sectional view of a ported shroud according to an embodiment; and

FIG. 4 is a perspective view of a centrifugal compressor including a ported shroud according to an embodiment.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

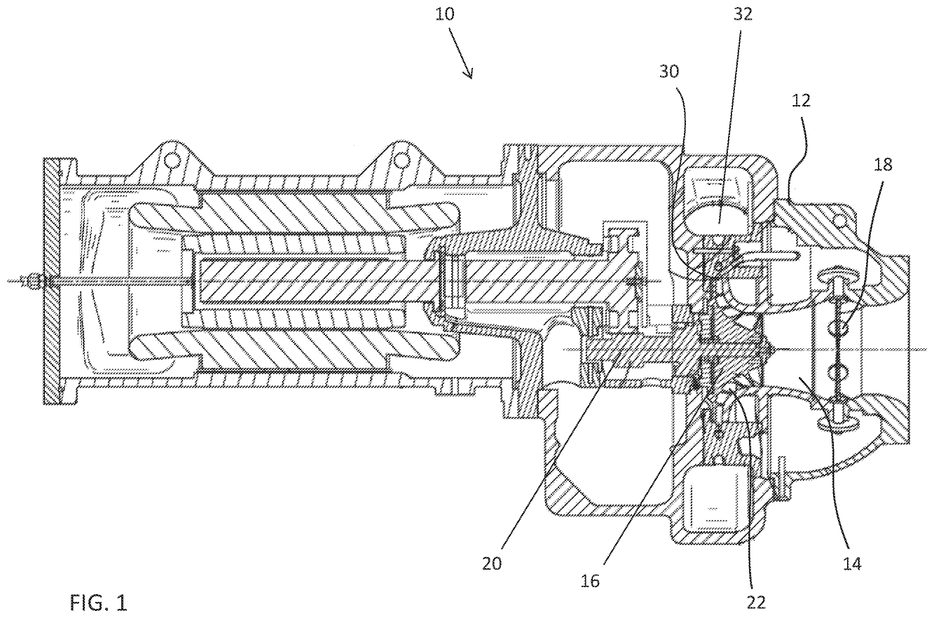

Referring now to FIG. 1, an example of an existing centrifitgal compressor 10 is illustrated. As shown, the centrifugal compressor 10 includes a main casing 12 having an inlet 14 that directs refrigerant into a rotating impeller 16. Although not shown, in some embodiments, the refrigerant may pass through a series of adjustable inlet guide vanes prior to reaching the impeller 16, The impeller 16 is secured to a drive shaft 20 by any suitable means to align impeller 16 along the axis of the compressor 10. The impeller 16 has a plurality of passages 22 formed therein that cause the incoming axial flow of a refrigerant fluid to turn in a radial direction and discharge into an adjacent diffuser section 30. The diffuser section 30 is disposed generally circumferentially about the impeller 16 and functions to direct the compressed refrigerant fluid into a toroidal-shaped volute 32, which directs the compressed fluid toward a compressor outlet, or alternatively, toward a second stage of the compressor 10 (not shown), depending on the configuration of the compressor.

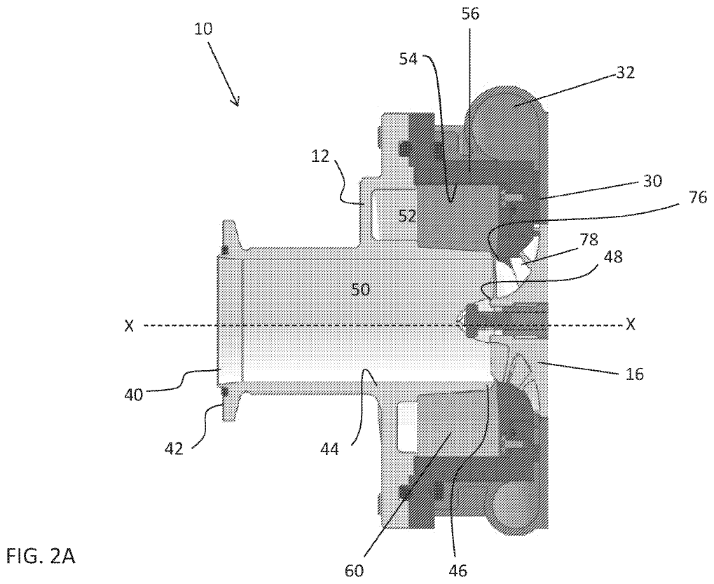

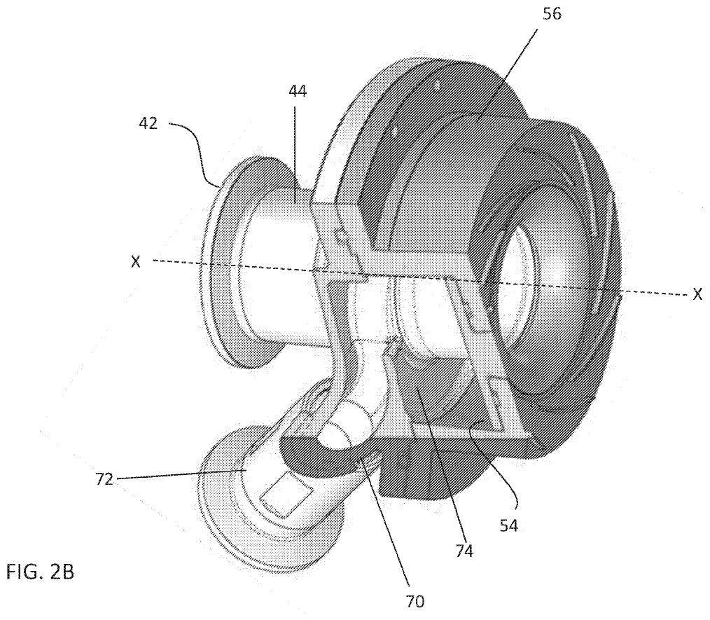

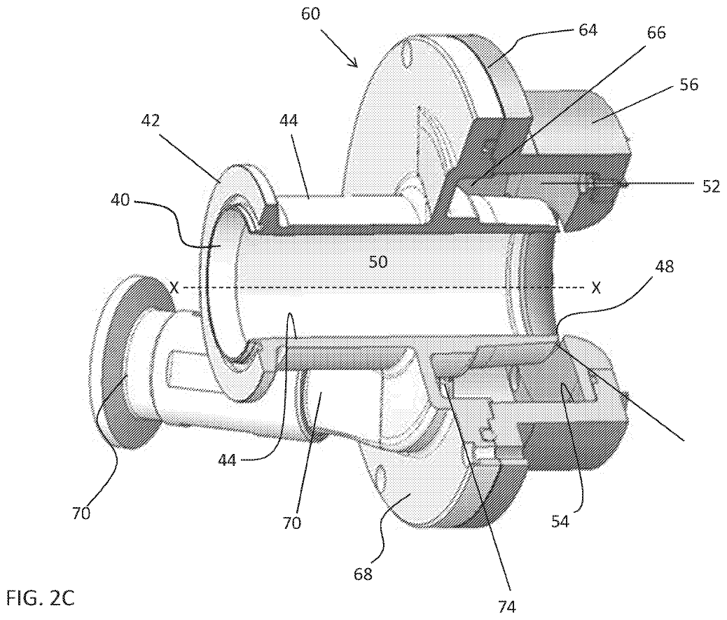

With reference now to FIGS. 2-4, an example of a centrifugal compressor having a ported shroud according to an embodiment is illustrated. As shown, the main casing or housing 12 includes an opening 40 formed at a first end 42 thereof. The housing 12 additionally includes a wall 44 having a second end 46 arranged generally adjacent the upstream end 48 of the impeller 16. The axial passageway 50 defined by an interior of the wall 44 fluidly couples the inlet opening 40 to the impeller 16 to direct a flow of fluid, such as refrigerant for example, to the impeller 16. Together, the inlet opening 40 and the axial passageway 50 form the previously described inlet 14.

A clearance 52 is arranged adjacent at least a portion of the internal wall 44. In the illustrated, non-limiting embodiment, the clearance 52 is disposed concentrically with the wall 44, for example extending between an exterior surface of the wall 44 and a surface 54 of a diffuser structure 56 that defines an outer wall of the diffuser 30. As a result, the clearance 52 is arranged generally parallel to the axis of rotation X of the impeller 16 and shaft 20. Further, the clearance 52 may extend from adjacent the upstream end 48 of the impeller 16 over all or a portion of the axial length of the passageway 50.

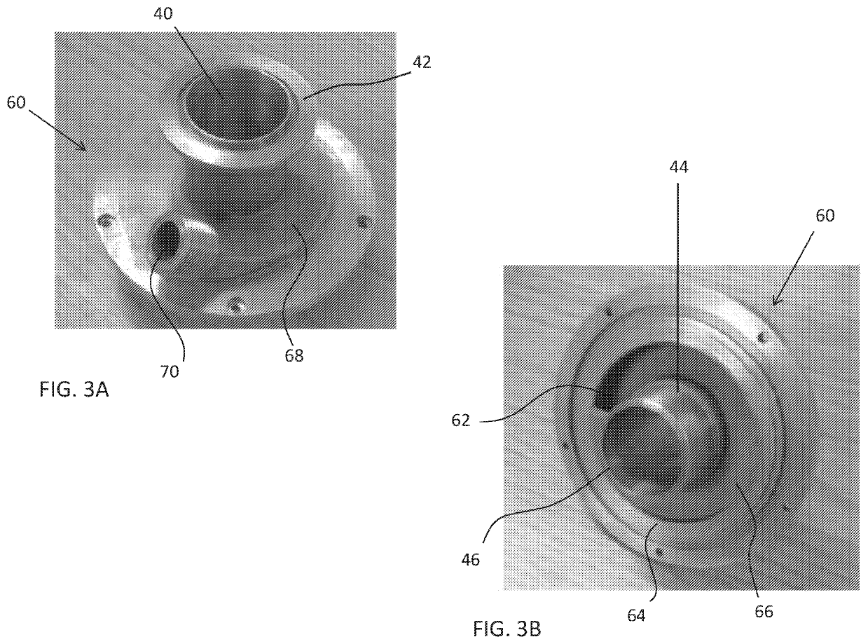

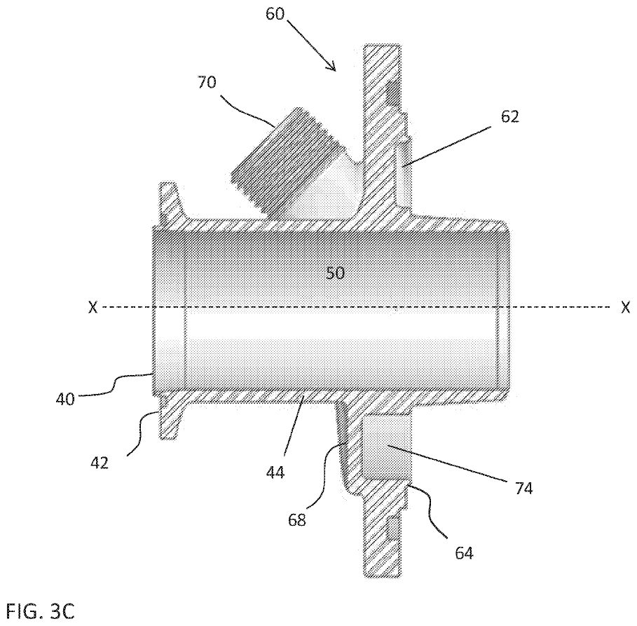

In the illustrated, non-limiting embodiment, a shroud 60 is arranged in fluid communication with the clearance 52. The shroud 60 may be integrally formed with the housing 12, and more specifically the wall 44 of the housing 12 as shown in FIGS. 3A-3C, or alternatively, may be a separate component configured to permanently or removably couple to the housing 12. An inlet 62 for receiving a fluid flow is formed adjacent a first, downstream end of 64 the shroud 60. In the illustrated embodiment, the inlet 62 includes a slot 66 that wraps about the circumference of the internal wall 44 of the housing 12. As shown, the slot 66 is defined by a ramped surface that gradually increases in distance from the first end 64 of the shroud 60 about the circumferential length of the slot 66. The distance is measured parallel to the axis X of impeller 16 and extends from the first end 64 of the shroud 60 towards a second, opposite end 68 of the shroud 60.

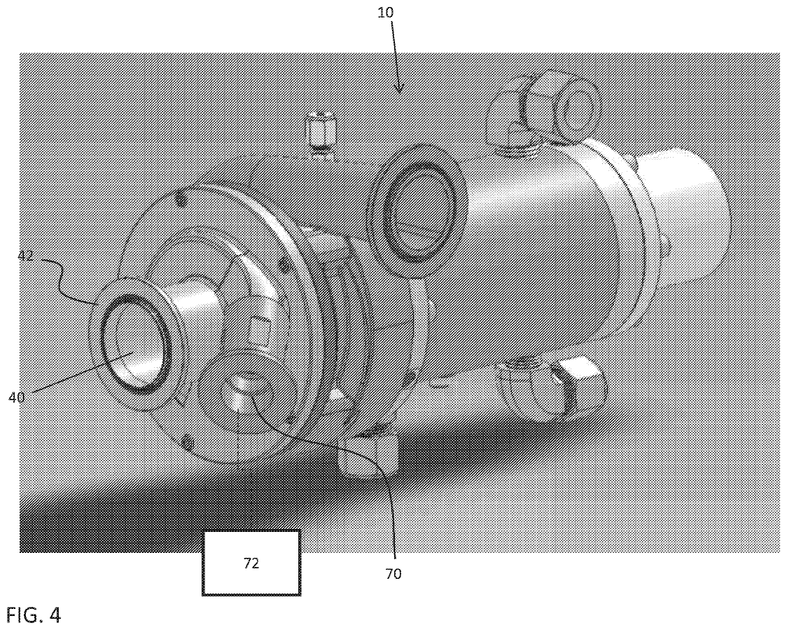

An outlet 70 is formed adjacent a second, upstream end 68 of the shroud 60. In the illustrated, non-limiting embodiment, the outlet 70 is formed as a cylindrical pipe fitting having a plurality of threads formed about an outer periphery thereof for connection with another component external 72 to the compressor 10 (see FIG. 4). In an embodiment, the outlet 70 of the shroud 60 may be fluidly coupled to an evaporator. Alternatively, the outlet 70 may be coupled to a suction line (not shown) upstream from the compressor inlet 14. A volute 74 is defined within the hollow interior of the shroud 60, extending between inlet 62 and the outlet 70. In an embodiment, the volute 74 may be general toroidal in shape such that the fluid flow continues to circulate about the periphery of the axial passageway 50 as the fluid travels from the inlet 62, through the volute 74 to the outlet 70.

As best shown in FIG. 2A, when installed within the compressor 10, the first, downstream end 64 of the shroud 60 is positioned generally adjacent the upstream end 48 of the impeller 16. In an embodiment, the inlet 62 or slot 66 formed in the first end 64 is generally aligned with the leading edge 76 of the impeller blades 78. In addition, the outlet 70 of the ported shroud 60 may be exposed at an exterior of the housing 12.

As previously described, during operation of the compressor 10, a flow of fluid, such as refrigerant for example, is provided to the inlet opening 40 and flows through the axial passage 50 defined by the internal wall 44 to the impeller 16. The ported shroud 60 is operable in a plurality of modes based on the desired performance of the compressor 10. During a first mode of operation, the ported shroud 60 may be used to reduce the flow provided to the impeller 16. In such an outflow mode of operation, a portion of the flow provided to the impeller 16 is drawn into the inlet opening 62 from adjacent the leading edge 76 of the impeller blades 78, thereby reducing the total amount of flow provided to the impeller 16. The portion of the flow provided to the ported shroud 60 collects within the volute 74 before being discharged through the outlet opening 70 to another component 72. During a second mode of operation, the ported shroud 60 may be used to increase the fluid flow provided to the impeller 16. In an inflow mode of operation, a portion of fluid flow is provided to the outlet opening 70 for collection within the volute 74. From the volute 74, the fluid travels through the inlet opening 62 and is discharged adjacent the leading edge 76 of the impeller blades 78. This flow from the ported shroud 60 is supplemental to the flow provided to the impeller 16 via the inlet opening 40 and axial passageway 50 of the housing 12.

A compressor 10 including the ported shroud 60 illustrated and described herein provides the benefit of an aspirated shroud bleed on the impeller operating range, while mitigating the inlet distortion generated by the outlet of the port.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A ported shroud for use in a compressor, comprising:
a body having a first end and a second opposite end, the body being disposed concentrically about an axial passageway;
an inlet for receiving a fluid flow formed adjacent the first end;
an outlet port for discharging the fluid flow formed adjacent the second end; and
a toroidal volute disposed within the interior of the body and fluidly coupling the inlet and the outlet.

2. The ported shroud of claim 1, wherein at least one of a size and contour of the inlet is selected based on a pressure distribution within the compressor.

3. The ported shroud of claim 1, wherein the inlet includes a slot.

4. The ported shroud of claim 3, wherein the slot extends circumferentially about the axial passageway.

5. The ported shroud of claim 3, wherein the slot includes a ramped surface extending from the first end toward the second end.

6. The ported shroud of claim 5, wherein the ramped surface gradually increases in distance from the first end about a circumferential of the axial passageway, the distance being measured parallel to an axis of the axial passageway.

7. A compressor comprising:
a housing including an inlet opening formed at a first end of the housing and an internal wall extending from the inlet opening to define a passageway;
an impeller including at least one impeller blade, the impeller being rotatable about an axis and positioned adjacent an end of the passageway for receiving a fluid flow there through; and
a ported shroud positioned adjacent at least a portion of the internal wall, wherein the ported shroud includes an internal volute and includes a first opening in fluid communication with a leading edge of the at least one impeller blade.

8. The compressor of claim 7, wherein the ported shroud includes a second opening in fluid communication with a component external to the compressor.

9. The compressor of claim 8, wherein during outflow operation, fluid is provided to the ported shroud through the first opening and is discharged from the ported shroud through the second opening.

10. The compressor of claim 8, wherein during inflow operation, fluid is provided to the ported shroud through the second opening and is discharged from the ported shroud through the first opening.

11. The compressor of claim 7, wherein the ported shroud is integrally formed with the internal wall of the housing.

12. The compressor of claim 7, wherein the ported shroud is coupled to the internal wall of the housing.

13. The compressor of claim 7, wherein the internal volute is toroidal in shape.

14. The compressor of claim 13, wherein the internal volute extends about the periphery of the internal wall.

15. The compressor of claim 7, wherein at least one of a size and contour of the first opening is selected based on a pressure distribution within the compressor.

16. The compressor of claim 7, wherein the first opening includes a slot.

17. The compressor of claim 16, wherein the slot extends circumferentially about the axial passageway.

18. The compressor of claim 16, wherein the slot includes a ramped surface extending from the first end toward the second end.

19. The compressor of claim 18, wherein the ramped surface gradually increases in distance from the first end about a circumferential of the axial passageway, the distance being measured parallel to an axis of the axial passageway.
